(19) United States
(12) Patent Application Publication
(10) Pub. No.: US 2017/0291296 A1
(43) Pub. Date: Oct. 12, 2017

(54) HIGH PRECISION WORK PIECE PROCESSING SYSTEM

(71) Applicant: Ascent Aerospace, Santa Ana, CA (US)

(72) Inventor: Mark W. Brown, Richmond, MI (US)

(73) Assignee: Ascent Aerospace, Santa Ana, CA (US)

(21) Appl. No.: 15/485,558

(22) Filed: Apr. 12, 2017

Related U.S. Application Data
(60) Provisional application No. 62/321,365, filed on Apr. 12, 2016.

(51) Int. Cl. B25J 9/04; B25J 17/02; B23K 9/095; B25J 19/00; B23K 37/02; B23K 37/053; B23K 9/28; B25J 18/00

(52) U.S. Cl. CPC B25J 9/042; B23K 9/287; B25J 17/0275; B25J 18/007; B25J 19/0025; B23K 37/0229; B23K 37/0276; B23K 37/0533; B23K 9/0953

(57) ABSTRACT

The present invention provides a work piece processing system for operating on a work piece or at least one component of a work piece. The processing system includes a base system for transporting the at least one work piece component, at least one processing head for operating on the work piece component, and means for controlling, the means for controlling the processing system. In a first embodiment, the processing system further includes a support structure, the support structure including at least one frame member having a track. Here, the at least one processing head travels along the track. In a second embodiment, the processing system further includes a multi-linkage robotic arm, the robotic arm including a plurality of rotary joints and a plurality of arm segments interconnecting the rotary joints. Here, the at least one processing head is operably mounted to a free end of one of the plurality of arm segments.

### CROSS-REFERENCE TO RELATED APPLICATION

This application is a completion application which claims the priority benefit of co-pending U.S. Provisional Patent Application Ser. No. 62/321,365, filed Apr. 12, 2016, for “High Precision Work Piece Processing System,” the disclosure of which is hereby incorporated by reference in its entirety, including the drawing.

### BACKGROUND OF THE INVENTION

### 1. Field of the Invention

The present invention pertains to precision manufacturing of high tolerance work piece components. More particularly, the present invention concerns a work piece processing system for precision manufacturing around and about at least a portion of the periphery of a work piece or a component thereof. Even more particularly, the present invention concerns a processing system for high tolerance manufacturing aerospace work piece components.

### 2. Description of Related Art

A number of different processing systems or apparatuses are used during the manufacturing process of various types of work pieces, equipment, or machinery. These processing systems are each tasked with a specific assembly function during the course of constructing the work piece from its various components. These functions include cutting, shaping, drilling, welding, finishing, polishing, and a number of other procedures performed on at least one work piece component. Additionally, it is essential that the processing system be able to process at least a portion of the periphery of the work piece component without it having to be repositioned, which costs time and money.

The prior art has proposed potential solutions to this issue by each teaching apparatuses and/or methods for operating on a work piece component having a high range of motion.

For example, U.S. Patent Publication No. 2011/0049105 to Dupont et al. teaches an orbital carrier including two semicircular components for welding together two pipes. These two semicircular components open and close proximate opposed sides, thus securing the pipes within the orbital carrier. Each semicircular component includes a guide rail and at least one welding head that moves along the guide rail in order to weld abutting ends of the pipes together. While the structure of the orbital carrier allows the welding head to operate around the periphery of the pipes, the welding head is limited to a 180° range of motion because the welding head cannot move between guide rails of both semicircular components. Therefore, at least two welding heads, one on each semicircular component, are required in order to operate in a 360° fashion. Furthermore, the work piece component remains stationary instead of moving along an axial plane during use. Thus, the welding head is limited to working on a small, radial section of the pipes unless the orbital carrier or pipes are manually repositioned.

U.S. Pat. No. 5,171,954 to Rinaldi provides a method for welding abutting ends of opposed pipes together, similar to that taught in Dupont et al., by using a ring piece having a track which surrounds the pipes. A welding carrier, including a welding lance, is disposed on the ring piece and travels along the entire circumference of the ring piece. As the welding carrier moves to its specified locations, the welding lance then welds the abutting ends of the pipes together. As with Dupont et al., the welding pipes are secured within the ring piece and remain stationary during operation. This restricts the welding lance to operate on only a small circular strip of the pipes before having to manually readjust the pipes to a new position.

Additionally, while each of the devices and methods disclosed in the above references are suitable for the uses and problems they intend to solve, there is an ongoing need for improvements in a work piece processing system such as one that can operate on at least a portion of the periphery of a work piece component.

It is to this to which the present invention is directed.

### SUMMARY OF THE INVENTION

The present invention provides a work piece processing system for operating on at least a portion of the periphery of at least one component of a work piece. The work piece processing system comprises: (a) a base system for transporting at least one component of a work piece; (b) at least one processing head for operating on at least a portion of the periphery of the at least one work piece component; and (c) means for controlling, the means for controlling the processing system, the means for controlling being in electrical communication with the base system and the at least one processing head.

In a first embodiment hereof, the work piece processing system further comprises: a support structure including at least one frame member, the at least one frame member including a track disposed proximate the perimeter thereof, the track defining an opening formed within the at least one frame member, the track encircling at least a portion of the base system. The track can either be a complete circle providing a 360° track or an arc having less than a 360° path.

The processing head is rotatable, horizontally and/or vertically, around the work piece component to enable traveling along the track with up to a 360° range of motion when the track is a complete circle. As the processing head travels along the track, at least a portion of the periphery of the work piece component can be processed without having to manually reposition the support structure itself.

The base system comprises: (a) a base module assembly including a plurality of base module segments; and (b) a transport sled assembly including a plurality of transport sled segments, each assembly extending longitudinally and intersecting the opening in the frame member. The base system transports the work piece component through the opening of the frame member and positions the work piece component in a desired axial position.

Where the track forms a complete circle, a gap is formed between individual segments in each of the base module assembly and the transport sled assembly to provide a clearance for the processing head to move therebetween.

In an alternative embodiment, the work piece processing system comprises: a multi-linkage robotic arm, the robotic arm including a plurality of rotary joints and a plurality of arm segments interconnecting the rotary joints; and wherein the at least one processing head is mounted on a free end of one of the plurality of arm segments.

Here, the robotic arm positions the processing head to any location on the work piece component as the work piece component is positioned as discussed with regards to the above first embodiment.

For a better understanding of the present invention, reference is made to the accompanying drawing and detailed description. In the drawing, like reference characters refer to like parts through the several views, in which:

### BRIEF DESCRIPTION OF THE DRAWING

FIG. 1 is a perspective view of a work piece processing system in accordance with a first embodiment of the present invention;

FIG. 2 is a perspective view of a base module segment;

FIG. 3 is a partial, perspective view of means for linearly moving an associated transport sled segment, the means being a first rotary motor;

FIG. 4 is a perspective view of an assembled base module assembly comprising a plurality of base module segments;

FIG. 5 is a perspective view of the base module assembly having a gap formed therein;

FIG. 6 is a perspective view of the base module assembly mounted on a platform;

FIG. 7 is a perspective view of the platform having a pit provided therein;

FIG. 8 is a perspective view of the platform mounted atop a plurality of pedestals;

FIG. 9 is a perspective view of a transport sled segment;

FIG. 10 is a perspective view of the first rotary motor engaging the transport sled segment;

FIG. 11 is a perspective view of a transport sled segment disposed atop a base module segment;

FIG. 12 is a perspective view of an assembled transport sled assembly comprising a plurality of transport sled segments and a plurality of stabilizing components mounted thereon;

FIG. 13 is a perspective view of a work piece component disposed atop the transport sled assembly;

FIG. 14 is a perspective view of the support structure including a plurality of frame members;

FIG. 15a is a perspective view of the support structure wherein the processing head horizontally translatable within a gap between the plurality of frame members;

FIG. 15b is a perspective of the support structure including a plurality of frame members, each having a track providing less than a 360° arc;

FIG. 16 is a perspective view of an alternative embodiment of the present invention; and

FIG. 17 is a perspective view of an alternative embodiment of the means for linearly moving the transport sled segments, the means being a drop pin configuration for incremental positioning.

### DETAILED DESCRIPTION OF THE INVENTION

It is to be understood that the prevent invention can process either a single work an entire, integrally formed work piece or at least one component of a work piece. However, for purposes of simplicity, reference will be made to a work piece component throughout the ensuing description and appended claims. Preferably, the work piece component is a large aerospace component such as a fuselage, wing, engine, and the like. Nonetheless, it is to be understood that the present invention is not to be construed as limited to aerospace components, but equally pertains to submarines, rockets, railroad cars, boats, and the like. Therefore, the size and structure of the work piece component may vary without deviating from the scope of the present invention.

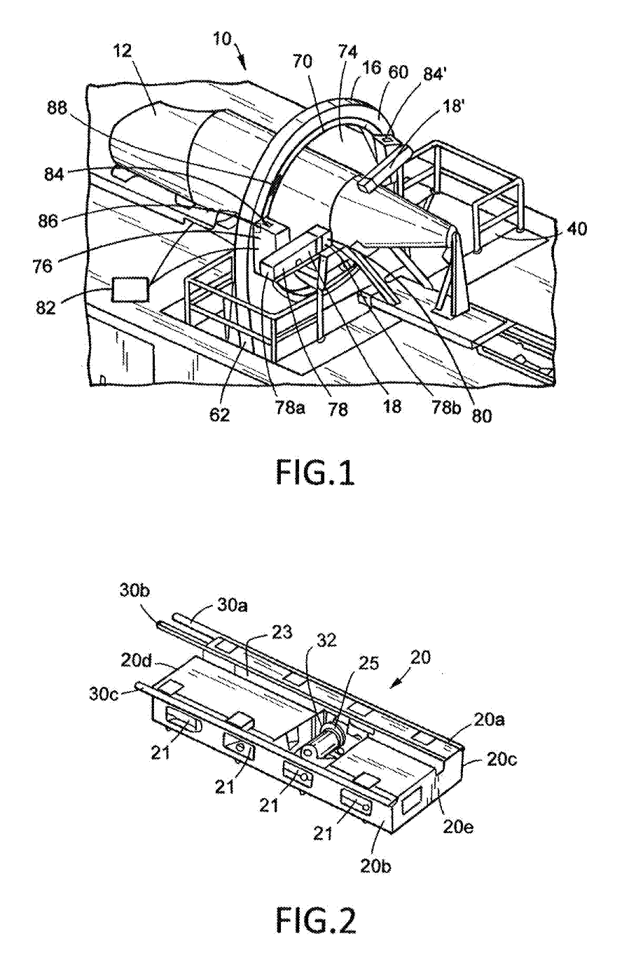

Now, and in accordance with a first embodiment of the present invention and with reference to FIG. 1 of the drawing, there is provided a work piece processing system, denoted at 10, for operating on an entire work piece or a component 12 thereof.

The processing system 10, generally, comprises: (a) a base system 14 for transporting the work piece component 12; (b) a support structure 16, the base system 14 extending through the support structure 16; (c) at least one processing head 18 traveling within the support structure 16; and (d) means for controlling 82, the means for controlling 82 the processing system 10.

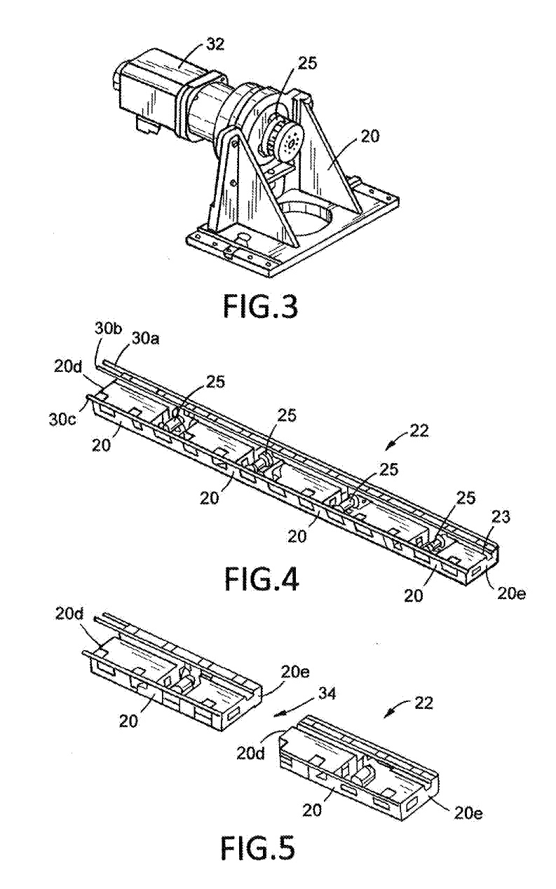

Referring now to FIGS. 2-13, the base system 14 comprises: (a) a plurality of cooperable base module segments 20 providing a uniform, elongated base module assembly 22 when assembled; (b) a platform 24, the base module assembly 22 being mounted atop the platform 24; (c) a plurality of cooperable transport sled segments 26 providing a uniform, elongated transport sled assembly 28 slidably mounted atop the base module assembly 22; and (d) a plurality of work piece holders or stabilizing components 54 mounted atop the transport sled segments 26 for supporting the work piece component 12.

While it is preferred that the base module assembly 22 and the transport sled assembly 28 each comprise a plurality of segments as described throughout, it is to be understood that the base module assembly 22 and the transport sled assembly 28 may each comprise a single, integrally formed, irregularly shaped structure. Nonetheless, the segmented configuration provides additional benefits such as transportation of the processing system 10 and replacement of individual components when necessary.

Each one of the plurality of base module segments 20 comprises a top surface 20a, a pair of opposed sidewalls 20b, 20c extending downwardly from the top surface 20a, and a pair of opposed, abutting ends 20d, 20e extending downwardly from the top surface 20a and interconnecting the sidewalls 20b, 20c.

A plurality of apertures 21 are formed within the sidewalls 20b, 20c of each base module segment 20. The apertures enable the base module segments 20 to be secured to the platform 24 by inserting any suitable fastening means (not shown), such as bolts, screws, and the like, therein.

Each base module segment 20 further includes a cavity 23 formed within the top surface 20a, which extends longitudinally between abutting ends 20d, 20e. As explained below, the cavity 23 is configured to engage a mating leg 27 on each transport sled segment 26.

The base module segments 20 are formed from any suitable material such as steel, iron, rigid plastic, aluminum, and the like. It is preferred that each base module segment 20 be substantially rectangular in shape. However, the base module segments 20 can be configured to any geometric shape as desired. It is understood that these specifications may vary based on the size and shape of the work piece component 12 being processed.

The base module segment 20 further comprises at least one guide rail, three of which are shown at 30a, 30b, 30c. The guide rails 30a, 30b, 30c are disposed proximate the top surface 20a of the base module segment 20. A plurality of roller arrays or sliding elements 50a, 50b, 50c disposed on the transport sled segment 26 mate with the guide rails 30a, 30b, 30c, respectively, in order to facilitate and stabilize the horizontally, translating movement of the transport sled segment 20.

FIG. 4 shows the plurality of base module segments 20 assembled in an elongated fashion by connecting abutting ends 20d, 20e of adjacent base module segments 20 to one another using any suitable fastening means, such as bolts, screws, clips, and the like, thus forming the elongated base module assembly 22.

As shown in FIG. 5, a gap 34 may be provided between a pair of spaced apart base module segments 20. The gap 34 provides a space for the processing head 18 to pass therebetween in order to access the underside of the work piece component 12. It is to be understood that the gap 34 is not necessary where the processing head 18 does not travel below the base assembly 14.

The base system 14 further comprises means 33 for linearly moving the transport sled segments 26 atop the base module segments 20. The means 33 may comprise either an air float, a rotary motor providing linear motion, a linear motor, a manual drop pin arrangement for indexable positioning, a precision carriage, or the like. Based on the means 33 employed, the transport sled segments 26 may be infinitely or, alternatively, incrementally positionable along the base module segments 20. The means 33 is disposed within either the base module segments 20 or the transport sled segments 26 in order to provide linear translation of the transport sled segments 26. Rotary and linear motors are well-known and commercially available such as those sold by Siemens and Bosch.

As shown in FIGS. 2-5, 10, and 11, it is preferred that the means for linearly moving 33 comprises a first rotary motor 32 having angular feedback capabilities which causes linear motion of the transport sled assembly 26 with respect to the base module assembly 22. The first rotary motor 32 is disposed within each base module segment 20 and includes a pinion gear 25 disposed within the cavity 23. Here, the pinion gear 25 engages a rack 31 mounted on the leg 27 of the transport sled segment 26, as described below, which enables the transport sled segments 26 to tandemly transport the work piece component 12 across the base module segment 20 in a horizontal manner.

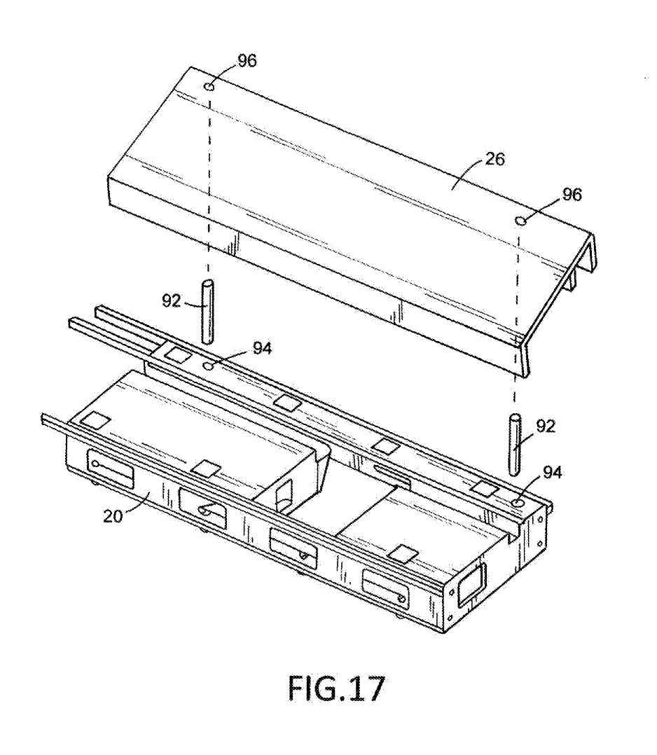

As noted above, and with reference to FIG. 17, the transport sled segments 26 may, alternatively, be manually operated above the base module segments 20. Here, the means 33 comprises a drop pin arrangement including at least one drop pin 92 removably insertable into a pair of openings 92, 94 formed in both the base module segments 20 and the transport sled segments 26, respectively. This provides incremental positioning of the transport sled segments 26 above the base module segments 20 without the use of any motors, actuators, or the like. Once an operator appropriately positions the transport sled segments 26 in relation to a respective base module segment 20 and the openings 94, 96 are in registry with one another, the operator inserts the at least one drop pin 92 into the openings 94, 96, thereby locking the transport sled segment 26 in place.

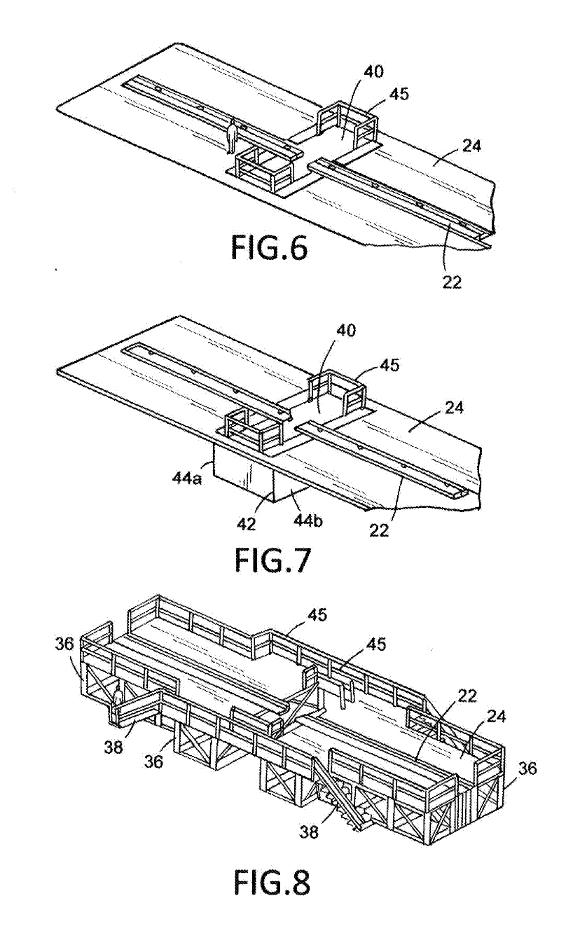

As shown in FIGS. 6-8, the elongated base module assembly 22 lies in an X-axis and is mounted to the platform 24 with any suitable means for fastening, such as screws, bolts, and the like (not shown), insertable through the plurality of apertures 21 shown in FIG. 2. The means for fastening allows for future disassembly of the base module assembly 22 from the platform 24.

The platform 24 is a horizontally extending planar structure that provides a work space for personnel to inspect the processing system 10. The platform 24 can either be located at ground level (FIGS. 6 and 7) or elevated by placing the platform 24 atop a plurality of pedestals 36 (FIG. 8). When the platform 24 is above ground level, the base system 14, preferably, includes stairs 38 leading from the ground level to the platform 24.

In either instance, the platform 24 provides an opening 40 at a substantially central portion thereof. The opening 40 allows for the support structure 16, as described below, to be disposed below the platform 24 and extend therethrough. Thus, the processing head 18 is able to operate below the base module assembly 22.

As shown in FIG. 7, a substantially enclosed pit 42 may be provided below the opening 40. The pit 42 is defined by at least a pair of sidewalls 44a, 44b extending downwardly from the platform 24 proximate the opening 40. The processing head 18 is disposed within the pit 42, Preferably, the pit 42 provides an enclosed area for the processing head 18 to process on the work piece component 12 from the underside while reducing any risk of outside, physical interference.

Preferably, for safety measures, a railing 45 is provided along the perimeter of the platform 24, as well as the opening 40 itself, to reduce the chances of personnel stepping off the platform 24 and into a dangerous condition.

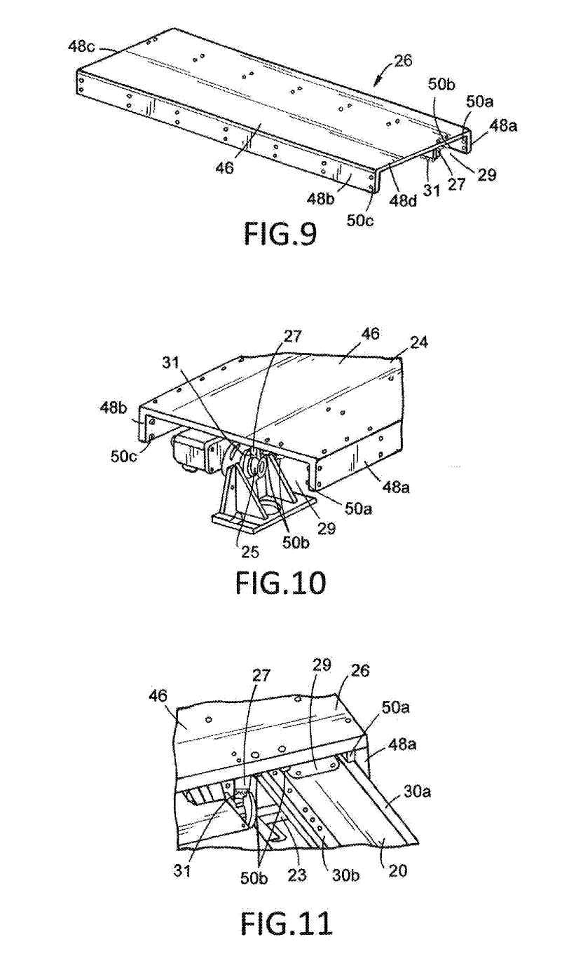

In FIGS. 9-11, there is shown each transport sled segment 26 as including a top surface 46, a pair of opposed sidewalls 48a, 48b extending downwardly from the top surface 46, and opposed, abutting ends 48c, 48d located at opposite sides of the top surface 46 between the sidewalls 48a, 48b.

In order for the transport sled segments 26 to slide over the base module segments 20, the transport sled segments 26 are dimensioned to mount over the top surface 20a of the base module segments 20 and slidably move along the top surface 20a thereof. Furthermore, each transport sled segment 26 includes a leg 27 extending downwardly from the top surface 46. Each leg 27 extends linearly between the abutting ends 48c, 48d of its associated transport sled segment 26 and mates with its cavity 23 in the base module segments 20. A channel 29 is defined between the leg 27 and the sidewall 48a.

A plurality of roller arrays or sliding elements 50a, 50b, 50c are secured to each of the transport sled segments 26 to further assist in allowing the transport sled segments 26 to slide over the base module segments 20. A first roller array 50a is secured to sidewall 44a of the transport sled segment 26 within the channel 29 and mates with the first guide rail 30a. A second roller array 50b is mounted below the top surface 46, directed downwardly and within the channel 29, and mates with the second guide rail 30b. A third roller array 50c is disposed on sidewall 48b and directed inwardly to mate with the third guide rail 30c. The relationship between the roller arrays 50a, 50b, 50c and their associated guide rails 30a, 30b, 30c ensure that the transport sled segment 26 translates over the base module segment 20 incurring minimal friction.

While it is described and illustrated that the plurality of roller arrays 50a, 50b, 50c are disposed on the transport sled segments 26 and the guide rails 30a, 30b, 30c are disposed on the base module segments 20, it is to be understood that the roller arrays 50a, 50b, 50c and the guide rails 30a, 30b, 30c may be disposed on opposite segments without deviating from the scope of the present invention.

Where the means 33 is a first rotary motor 32, a rack 31 is mounted along the associated leg 27 for engaging the pinion gear 25 of a respective first rotary motor 32. It is understood that the arrangement between the first rotary motor 32 and the rack 31 may be reversed such that that first rotary motor 32 is disposed on the transport sled segments 26 and the rack 31 is disposed on the base module segments 20.

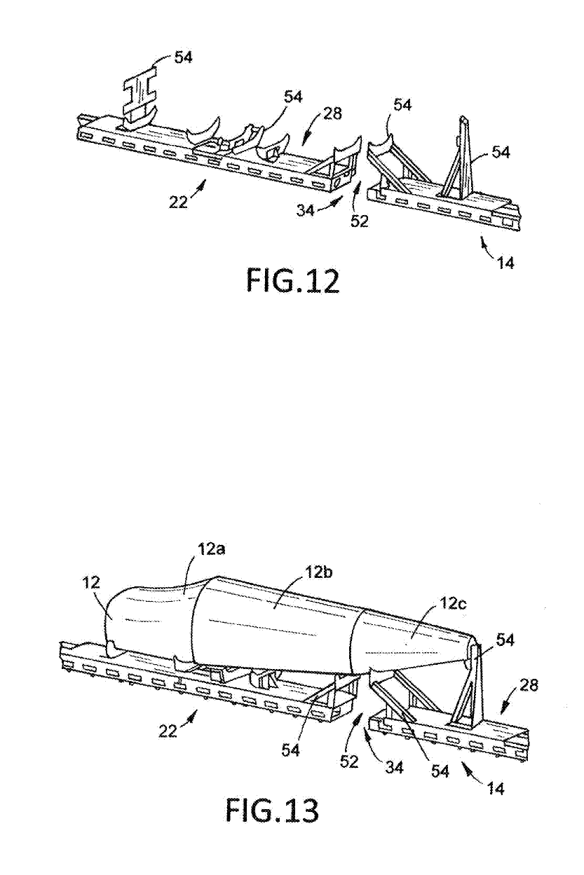

As shown in FIG. 12, the plurality of transport sled segments 26 is joined together using any suitable fastening means, such as screws, bolts, clips, and the like (not shown) in order to form a single transport sled assembly 28. The transport sled assembly 28 may also include at least one gap 52 between an adjacent pair of spaced apart transport sled segments 26, the gap 52 being wide enough to provide a clear path for the processing head 18 to operate therein, if necessary.

At least one work piece holder or stabilizing component 54 is mounted to the top surface 46 of any number of the transport sled segments 26 for maintaining the position of the work piece component 12 while being processed. It is understood that the configuration and placement of the at least one stabilizing component 54 is determined based on the shape and size of the work piece component 12.

FIG. 13 shows a plurality of distinct and separate work piece components 12a, 12b, 12c being processed simultaneously. Each work piece component 12a, 12b, 12c is supported by at least one transport sled segment 26. Here, when operating on a plurality of work piece components 12a, 12b, 12c, it may be desired that the entirety of the transport sled assembly 28 not move in unison. Therefore, the transport sled segments 26 can each move either synchronously or, alternatively, asynchronously in order to move the work piece components 12a, 12b, 12c relative to one another. Where the transport sled segments 26 move asynchronously, each of the means disposed within each base module segments 20 is controllable independent of one another.

Referring, again, to FIG. 1, the support structure 16, generally, comprises an upstanding frame member 60 either disposed atop the platform 24 or within the opening 40 formed therein. The frame member 60 is, generally, a substantially arcuate member and includes a base 62.

The frame member 60 also includes a track 70 which has a circumference that lies in an A-axis. The track 70 may provide an entire 360° arc where the processing head 18 can fully encircle the work piece component 12 or, alternatively, the track 70 may be discontinuous or terminate at some point therein where the processing head 18 is limited to rotate less than 360°, yet still, preferably, a substantial portion of the periphery of the work piece 12. Further, the track 70 is not limited to a circular configuration and may comprise any geographic or irregular shape formed within the frame member 60.

Preferably, the track provides a complete 360° arc in the frame member 60 and defines a circular opening 74 formed therein. The track 70 includes a rack 88, which cooperates with a pinion gear 86 on the processing head 18, discussed below, in order to allow the processing head 18 to travel along the track 70. The positioning of the rack 88 and the pinion gear 76 may be reversed similar to that discussed above with regards to the first rotary motor 32 in each of the base module segments 20 engaging the racks 31 in the transport sled segments 26.

It is to be understood that the track 70 does not need to provide a 360° range of motion, nor does the processing head 18 need to travel below the base system 14. In such instances, the gap 34 between individual segments of the base module assembly 22 and transport sled assembly 26 is not necessary.

In a first arrangement between the processing head 18 and the track 70, the processing head 18, generally, comprises a base 76, an arm 78 having a first end 78a and a second end 78b, and a tool receptor 80. The arm 78 is mounted to the base 76 proximate the first end 78a in any suitable manner by using gears, additional rotary motors, and the like. The tool receptor 80 is, similarly, mounted to the second end 78b of the arm 78 in any suitable manner by using gears, additional rotary motors, and the like as well. The base 76 is operably mounted to the track 70 of the frame member 60 via the rack 88 and the pinion gear 86. In use, a desired tool (not shown) is removably mounted to the tool receptor 80 based on the specific task to be accomplished. It is to be understood that any number of tools, including a processing head of varying size and functionality, may be used in connection with the present invention.

Where the processing head 18 includes a pinion gear 86 mounted thereon, the processing head 18 also includes a second rotary motor 84 with angular feedback in order to operate the pinion gear 86.

Alternatively, the rack 88 and the pinion gear 86 may be configured such that the track 70 includes a plurality of second rotary motors having associated pinion gears, and the processing head 18 includes a rack.

It is to be understood that the processing system 10 is capable of functioning with a plurality of processing heads 18, 18′, etc. simultaneously. Where a plurality of processing heads 18, 18′ is utilized and simultaneously travel along the A-axis of the track 70, the means for controlling 82, such as a personal computing device, tablet, data processor, or other suitable device, permits each processing head 18 to operate along only a section of the track 70. This ability ensures that the processing heads 18 each work on only a portion of the work piece component 12 within their designated range of motion, thereby avoiding a collision if more than one processing head 18 simultaneously attempts to operate at a single point along the track 70.

Here, it is preferred that the second rotary motors 84, 84′ in each one of a respective processing head 18, 18′ are individually controllable by the means for controlling 82.

As noted above, the means for controlling 82, which controls the processing system 10, is in electrical communication with the means 33 within each of the base module segments 20 and the at least one second rotary motor 84 mounted on either the processing head 18 or the track 70. The means for controlling 82 provides a user interface for inputting desired functions relative to the translation of the work piece component 12 and the movement of the processing head 18. The user can send any number of instructions regarding the desired positioning of the work piece component 12 or the job to be performed through the user interface of the means for controlling 82 and the processing system 10 can then calculate the necessary coordinates of the base system 14 and the processing head 18 to complete each action.

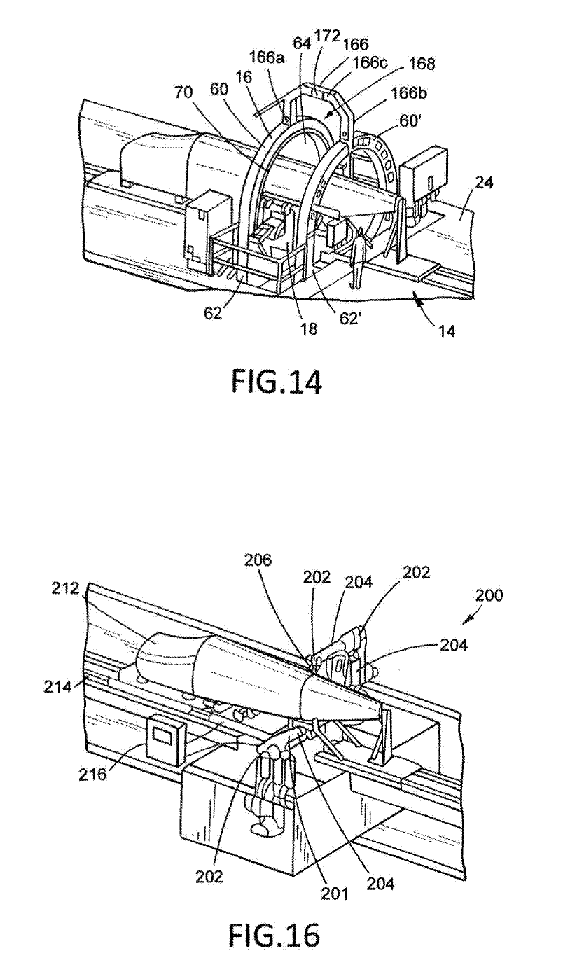

As shown in FIG. 14, the support structure 16 forms a gantry comprising a pair of spaced apart, upstanding frame members 60, 60′ mounted atop or within the pit 42 of the platform 24 of the base system 14. Each frame member 60, 60′ is, generally, an arcuate member and includes a base 62, 62′, respectively, in order to stabilize the frame members 60, 60′. A gap 64 is provided between the pair of frame members 60, 60′ to allow the processing head 18 to pass therebetween.

A connecting member 166 may be attached to each frame member 60, 60′ to maintain the position of the frame members 60, 60′ and minimize harmonics during operation. The connecting member 166 includes a first end 166a, a second end 166b, and a medial portion 166c interconnecting the first end 166a and the second end 166b. The connecting member 166 is a substantially U-shaped member which defines a void 168 formed therein for the processing head 18 to pass through during operation. The connecting member 166 is formed of a high strength material able to withstand the wear caused during use.

The first end 166a of the connecting member 166 is mounted to an associated frame member 60 and the second end 166b is mounted to the opposite frame member 60′. While the connecting member 166 may be mounted anywhere along the frame members 60, 60′, preferably, the connecting member 166 is attached to each frame member 60, 60′ at a top portion thereof in order to prevent the frame members 60a, 60′ from shifting out of place while, simultaneously, maintaining the width of the gap 64 during processing of the work piece component 12. Positioning the connecting member 166 on a side of the frame members 60, 60′ or proximate the base 62, 62′ provides less stability than being disposed at the top of the fame members 60, 60′. It is essential that the width of the gap 64 not increase or decrease throughout processing of the work piece component 12, otherwise the movement of the processing head 18 would be greatly affected.

The medial portion 166c of the connecting member 166 may include means for adjusting 172, such as a slidably extendable component, in order to modify the width of the gap 64 between the frame members 60, 60′ before and after processing the work piece component 12, but remain secured during processing. Using a connecting member 166, including the means for adjusting 172, allows the operator to secure the position of the frame members 60, 60′ using a single connecting member 166 instead of selecting one having a fixed width matching that of the desired gap 64.

Each frame member 60, 60′ of the support structure 16 comprises a substantially circular track 70 which defines an A-axis. Only one track 70 is shown on frame member 60, but it is to be understood that each track 70 comprises the same structure. Here, the processing head 18, or a plurality of processing heads 18 when employed, is operably mounted to each frame member 60, 60′ and simultaneously travel along the A-axis of the tracks 70.

The base module assembly 22 and the transport sled assembly 28 horizontally extend through each frame member 60, 60′ in order to appropriately position the work piece component 12 within the gap 64 for processing by the processing head 18.

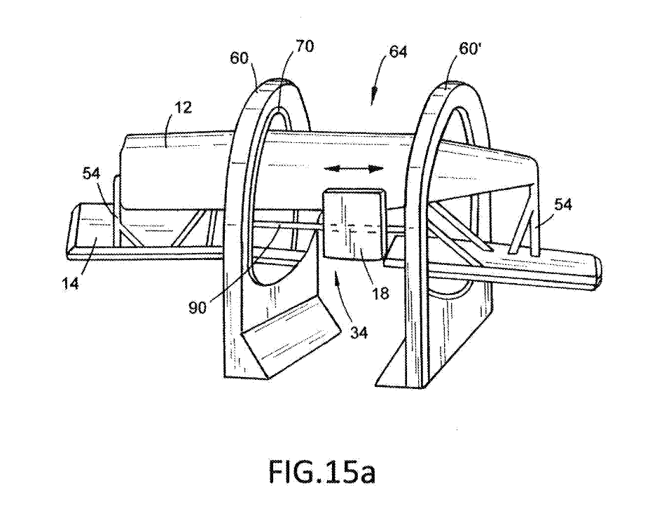

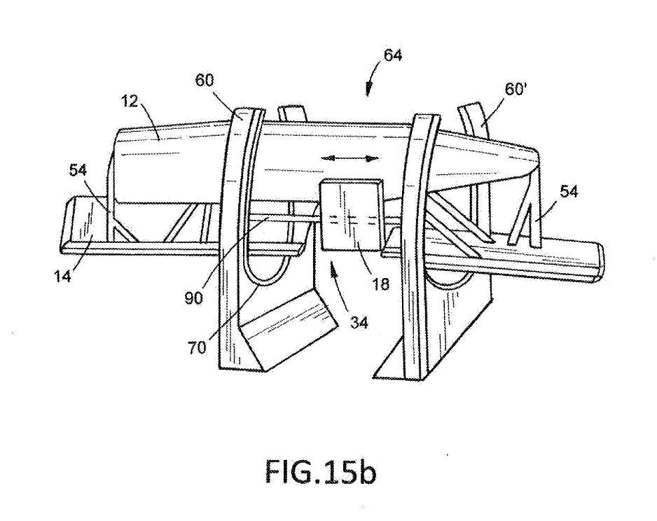

As shown in FIGS. 15a and 15b, in an alternative arrangement between the processing head 18 and the track 70, the support structure 16 further comprises a rail 90 extending between the pair of frame members 60, 60′ being operably connected to the tracks 70. The processing head 18 is mounted for horizontal translation along the rail 90. This allows the processing head 18 to operate in both a horizontal and vertical pattern by traveling along the rail 90 and rotate around the periphery of the work piece component 12 as the rail 90 travels along the tracks 70. This provides the added benefit of allowing the processing head 18 to process a larger area of the work piece component 12 in addition to merely a vertical strip before having to reposition the work piece component 12 within the gap 64.

While FIG. 15a shows the track 70 comprising a complete circular path providing a 360° path for rotation of the processing head 18, FIG. 15b includes a track 70 having less than a 360° path due to the tops of the frame members 60, 60′ being removed. It is to be understood that any portion of the track 70 may be removed or inoperable in order focus on only a portion of the work piece component 12. Further, the track 70 is not limited to a circular configuration and may comprise any geographic or irregular shape formed within the frame members 60, 60′.

In FIG. 16, an alternative embodiment of a work piece processing system 200 is depicted. Here, a multi-linkage robotic arm 201 is employed in lieu of the support structure 16. The robotic arm 201 includes a plurality of rotary joints 202 and a plurality of arm segments 204 interconnecting the rotary joints 202. A processing head 206 is mounted to an end of one of the segments 204 such that the robotic arm 201 can move the processing head 206 completely around the periphery of a work piece component 212. The robotic arm 201 additionally passes through a gap provided in a base system similar to the gaps described above with respect to the first embodiment.

All remaining components such as a base system 214 and means for controlling 216 are identical to like components with respect to the processing system 10 of the first embodiment.

From the above, it is to be appreciated that defined herein is a new and unique apparatus that provides a work piece processing system for translating a work piece component into a desired position and means for operating on at least a portion of the periphery of the work piece component.

### LIST OF REFERENCE NUMBERS

10 Work piece processing system
12 Work piece component
12a Work piece component
12b Work piece component
12c Work piece component
14 Base system
16 Support structure
18 Processing head
20 Base module segment
20a Top surface of base module segment
20b Sidewall of base module segment
20c Sidewall of base module segment
20d Abutting wall of base module segment
20e Abutting wall of base module segment
21 Apertures in sidewalls of base module segment
22 Base module assembly
23 Cavity in base module segment
24 Platform
25 Pinion gear
26 Transport sled segment
27 Leg of transport sled segment
28 Transport sled assembly
29 Channel of transport sled segment
30a Guide rail
30b Guide rail
30c Guide rail
31 Rack
32 First rotary motor
33 Means for linearly moving
34 Gap in base module assembly
36 Pedestals
38 Stairs on platform
40 Opening in platform
42 Pit in platform
44a Sidewalls of pit
44b Sidewalls of pit
45 Railing on platform
46 Top surface of transport sled segment
48a Sidewalls of transport sled segment
48b Sidewalls of transport sled segment
48c Abutting end of transport sled segment
48d Abutting end of transport sled segment
50a Roller array
50b Roller array
50c Roller array
52 Gap in transport sled assembly
54 Stabilizing components
60 Frame member
60′ Frame member
62 Base of frame member
62′ Base of frame member
64 Gap between frame members
70 Track on frame members
74 Opening in frame member
76 Base
78 Arm
78a First end of arm
78b Second end of arm
80 Tool end
82 Means for controlling
84 Second rotary motor
84′ Second rotary motor
86 Pinion gear
88 Rack
90 Rail
92 Drop pin
94 Opening in base module segment
96 Opening in transport sled segment
166 Connecting member
166a First end of connecting member
166b Second end of connecting member
166c Medial portion of connecting member
168 Void
172 Means for adjusting
200 Work piece processing system
201 Robot arm
202 Rotary joint
204 Arm segment
206 Processing head
212 Work piece component
214 Base system
216 Means for controlling

Having thus described the invention, what is claimed is:

1. A work piece processing system for operating on a work piece or at least one component of a work piece, the processing system comprising:
(a) a base system for transporting the at least one work piece component;
(b) at least one processing head for operating on at least a portion of the periphery of the at least one work piece component; and
(c) means for controlling, the means for controlling the processing system, the means for controlling being in electrical communication with the base system and the at least one processing head.

2. The processing system of claim 1 wherein the base system further comprises:
(a) a plurality of base module segments;
(b) a plurality of transport sled segments, each one of the plurality of transport sled segments being slidably mounted atop an associated one of the plurality of base module segments;
(c) means for linearly moving the transport sled segments; and
wherein the at least one work piece component is disposed atop the plurality of transport sled segments and the means for controlling is in electrical communication with the means for linearly moving in order to slide the plurality of transport sled segments across the plurality of base module segments.

3. The processing system of claim 2 wherein:
(a) each one of the plurality of base module segments further comprises at least one guide rail; and
(b) each one of the plurality of transport sled segments further comprises at least one roller array, the at least one roller array engaging the at least one guide rail to minimize friction as the plurality of transport sled segments travels over the plurality of base module segments.

4. The processing system of claim 2 further comprising:
a support structure including at least one frame member, the at least one frame member including a track, the track defining an opening formed within the at least one frame member, the track encircling at least a portion of the base system; and
wherein the at least one processing head travels along the track.

5. The processing system of claim 1 wherein the base system further comprises:
at least one stabilizing member mounted thereon for holding the at least one work piece component in position.

6. The processing system of claim 5 wherein the base system further comprises:
a plurality of stabilizing members mounted thereon for holding the at least one work piece component in position.

7. The processing system of claim 4 wherein the base system further comprises:
a platform, the platform having an opening formed therein; and
wherein the support structure extends upwardly through the opening in the platform.

8. The processing system of claim 4 wherein the support structure comprises:
a pair of spaced apart frame members, each one of the pair of frame members including a track, the track defining an opening formed therein, the track encircling at least a portion of the base system; and
wherein the at least one processing head travels along the track of each one of the pair of frame members.

9. The processing system of claim 8 wherein the support structure further comprises:
a connecting member, the connecting member being substantially U-shaped and including a first end, a second end, and a medial portion interconnecting the first and second ends, the connecting member interconnecting the pair of frame members at the first and second ends of the connecting member.

10. The processing system of claim 8 wherein the support structure further comprises:
a rail interconnecting the track of each one of the pair of frame members and operably mounted thereto for traveling along the track; and
wherein the processing head is operably mounted to the rail for horizontal movement therealong.

11. The processing system of claim 4 further comprising:
a plurality of processing heads, each one of the plurality of processing heads being operably mounted to the track of the frame member; and
wherein the means for controlling is in electrical communication with each one of the plurality of processing heads.

12. The processing system of claim 2 further comprising:
a multi-linkage robotic arm, the robotic arm including a plurality of rotary joints and a plurality of arm segments interconnecting the rotary joints; and
wherein the at least one processing head is mounted to a free end of one of the plurality of arm segments.

13. The processing system of claim 12 wherein:
(a) the means for linearly moving is a plurality of first rotary motors causing linear motion, each one of the first rotary motors including a pinion gear, each one of the plurality of first rotary motors being disposed in a respective one of the plurality of base module segments; and
(b) each one of the plurality of transport sled segments including a rack mounted thereto, the rack engaging an associated pinion gear.

14. The processing system of claim 12 wherein:
the means for linearly moving is a drop pin configuration including at least one drop pin insertable into associated openings formed in each one of the plurality of base module segments and each one of the plurality of transport sled segments, the at least one drop pin providing incremental positioning of the plurality of transport sled segments in relation to the plurality of base module segments when the openings are in registry with one another.

15. A work piece processing system for operating on a work piece or at least one component of a work piece, the processing system comprising:
(a) a base system for transporting the at least one work piece component;
(b) a support structure including at least one frame member, the at least one frame member including a track, the track defining an opening formed within the at least one frame member, the track encircling at least a portion of the base system; and
(c) at least one processing head for operating on at least a portion of the periphery of the at least one work piece component, the at least one processing head traveling along the track; and
(d) means for controlling, the means for controlling the processing system, the means for controlling being in electrical communication with the base system and the at least one processing head.

16. The processing system of claim 15 wherein the base system further comprises:
(a) a plurality of base module segments;
(b) a plurality of transport sled segments, each one of the plurality of transport sled segments being slidably mounted atop an associated one of the plurality of base module segments;
(c) means for linearly moving the transport sled segments; and
wherein the at least one work piece component is disposed atop the plurality of transport sled segments and the means for controlling is in electrical communication with the means for linearly moving in order to slide the plurality of transport sled segments across the plurality of base module segments.

17. The processing system of claim 15 wherein the track provides a 360° range of motion for the processing head.

18. The processing system of claim 17 wherein the base system further comprises:
at least one gap formed therein defining a clearance for the at least one processing head to pass therebetween during operation.

19. The processing system of claim 15 wherein the base system further comprises:
a platform, the platform having an opening formed therein; and
wherein the support structure extends upwardly through the opening in the platform.

20. The processing system of claim 15 wherein the support structure comprises:
a pair of spaced apart frame members, each one of the pair of frame members including a track, the track defining an opening formed therein, the track encircling at least a portion of the base system; and
wherein the at least one processing head travels along the track of each one of the pair of frame members.

21. A work piece processing system for operating on a work piece or at least one component of a work piece, the processing system comprising:
(a) a base system for transporting the at least one work piece component;
(b) a multi-linkage robotic arm, the robotic arm including a plurality of rotary joints and a plurality of arm segments interconnecting the rotary joints;
(c) at least one processing head for operating on at least a portion of the periphery of the at least one work piece component, the at least one processing head being mounted to a free end of one of the plurality of arm segments; and
(d) means for controlling, the means for controlling the processing system, the means for controlling being in electrical communication with the base system, the robotic arm, and the at least one processing head.

22. The processing system of claim 21 wherein the base system further comprises:
(a) a plurality of base module segments;
(b) a plurality of transport sled segments, each one of the plurality of transport sled segments being slidably mounted atop an associated one of the plurality of base module segments;
(c) means for linearly moving the transport sled segments; and
wherein the at least one work piece component is disposed atop the plurality of transport sled segments and the means for controlling is in electrical communication with the means for linearly moving in order to slide the plurality of transport sled segments across the plurality of base module segments.

23. The processing system of claim 22 wherein:
(a) the means for linearly moving is a plurality of first rotary motors causing linear motion, each one of the first rotary motors including a pinion gear, each one of the plurality of first rotary motors being disposed in a respective one of the plurality of base module segments; and
(b) each one of the plurality of transport sled segments including a rack mounted thereto, the rack engaging an associated pinion gear.

24. The processing system of claim 22 wherein:
the means for linearly moving is a drop pin configuration including at least one drop pin insertable into associated openings formed in each one of the plurality of base module segments and each one of the plurality of transport sled segments, the at least one drop pin providing incremental positioning of the plurality of transport sled segments in relation to the plurality of base module segments when the openings are in registry with one another.
